(19) United States
(12) Patent Application Publication
(10) Pub. No.: US 2007/0059436 A1
(43) Pub. Date: Mar. 15, 2007

(54) Method for surface processing, method for surface preparation for subsequent coating and devices for carrying out said methods

(76) Inventor: Ury Veniaminovich Dikun, Moscow (RU)

Correspondence Address: DARBY & DARBY P.C., P. O. BOX 5257, NEW YORK, NY, 10150-5257, US

(21) Appl. No.: 10/536,583

(22) PCT Filed: May 20, 2003
(86) PCT No.: PCT/RU03/00222

§ 371 Date: Jan. 3, 2006

(30) Foreign Application Priority Data
Oct. 24, 2002 (RU) 2002128473

(51) Int. Cl. B05D 3/04

(52) U.S. Cl. 427/2.26

(57) ABSTRACT

The inventions relate to processing product surfaces in order to provide them with properties like an increased resistance to the action of different surface breaking natural or technogenic factors. Said invention can be used for the ship repair industry, building engineering, the machine-building and oil-gas industries. The inventive method for processing product surfaces consists in preparing a surface and in applying a coating with the aid of accelerated particles. Said processing method is characterized in that the surface preparation and coating are carried out simultaneously by scanning the surface with separate two-phase flows. The method for preparing a surface for subsequent coating including the surface processing by particles which are accelerated by a gas flow is also disclosed, said method being characterized in that the preparation is carried out by scanning the surface with a two-phase flow. The inventive device for processing and preparing a product surface is also disclosed.

The invention relates to the area of processing of surfaces of articles in order to give them such properties, as an increased resistance to the influence of various surface-destroying factors of natural and artificial character. It may be used in ship-repair industry, in construction, industrial equipment manufacturing, in oil and gas industry. Using the proposed invention, one can restore initial size and mechanical properties of surfaces of articles made of various materials, which deteriorated in the course of exploitation of such articles. In particular, the invention can be used in building and using of bridges and tunnels, hydraulic systems, shipbuilding, automotive engineering, in maintenance of stationary and floating drilling platforms, water transportation, protection of concrete surfaces of bridges and buildings.

A known surface processing method, described in /1/ and selected as a prototype, includes: mechanical preparation of a surface of an article being processed, sputtering of particles of a material, accelerated and heated, so that their velocity and heat result in plastic deformation when the particles hit the surface up to their melting temperatures; ultrasound exposure, applied simultaneously with sputtering, at the sputtering spot at the moment when particles hit the surface.

A drawback of this method is the need to heat the applied particles to high temperature up to their melting temperature, which causes an intensive chemical interaction of the liquid surface of sputtered metal drops with gas flow, used for accelerating them, resulting in their chemical linking, and a local heating of article's surface by products of gas-thermal reaction. The local heating, interacting with the environment, results in an intensive surface oxidation at the sputtering zone. This known method is complicated, energy-consuming and, therefore, expensive, which makes it unacceptable for processing large-size articles with significant surface area. Moreover, the known method implies an essential time delay between the surface preparation and the coating application, resulting in the formation of oxide films at the surface of the material, and their subsequent destruction at the moment of sputtering. It makes the known method unacceptable for the application of coatings on the surfaces, constantly subjected to adverse effects of natural and/or manmade factors, against which the surface is to be protected, without removing the article from a zone of adverse effects. The known method implies the destruction of thin oxide films after mechanical processing, with subsequent degreasing of thin-walled metal article surfaces, since the ultrasound oscillator is located at the opposite side of the article relative to the sputtering spot.

A known surface processing method, described in /2/ and selected as a prototype, includes: delivering particles to the processed surface by a stream of gas, so that the particle trajectory is changed after the particles bounce from the processed surface, and the particles are directed at 60-75° to the tangent and at right angle to the generatrix.

A drawback of the known method is that the known method is designed mainly for processing of surfaces of small solids of rotation for plasma sputtering under stationary conditions. The presence of three nozzles, located at a given angle to each other, increases the total gas flow rate, complicates the design, and increases the overall dimensions and weight of the apparatus. Abrasive particles and products resulting from the surface destruction are discharged into the atmosphere, contaminating the environment. These drawbacks hinder the use of the device, under the field conditions, for processing large, elongated articles.

A known surface processing method, described in /3/ and selected as a prototype, includes: a source of compressed gas, which is connected by a gas pipe with a heating unit, a metering feeder and a supersonic nozzle. The heating unit outlet is connected directly to the supersonic nozzle inlet, which is connected, in the supercritical part, by a pipeline with the metering feeder outlet.

A drawback of this known device is that a preliminary surface preparation is needed before coating of the surface of an article. The fact that the heating unit is connected with the supersonic nozzle and that the powder particles are supplied into the extended supercritical part increases the overall dimensions and weight of the device. Moreover, supplying the powder into the supercritical part of the accelerating supersonic nozzle results in a non-uniform concentration of the powder particles at the cross-section of the accelerating gas flow, non-optimal particle velocity at the device outlet, excessive heating temperature of the accelerating gas. The fact that the metering feeder is in contact with atmosphere and that the powder is supplied by atmospheric air results in increased humidity and intensive oxidation of the coating powder material. The coating with this device implies the gas-powder flow to the article at atmospheric conditions in open space, and the discharge of unused powder into the environment, resulting in ecological contamination. These drawbacks hinder achieving quality coatings with uniform width and thickness without preliminary processing of the powder material of the article surface, wherein the article is used in humid and wet environment.

The problem, solved by the invention, is the development of a method and apparatus for processing elongated surfaces of large articles, used under the conditions of varying stress loads and temperatures, high humidity of environment and/or periodically wetted surface of the article, destructive alkaline or acid environment, and wherein the method allows for a preliminary recovery of corroded or deformed parts of the article. In addition, these method and apparatus should not damage the environment, that is, they should be environmentally friendly and not discharge waste into the environment. Moreover, the preparation of surfaces and the application of coatings to the surfaces should be effective and produce high quality of applied coatings while being power-efficient, inexpensive, and operating with good productivity.

The essence of the invention is as follows. A method of surface processing is proposed, which includes the preparation of a surface and the application of coating by accelerated particles. A distinctive feature of this processing method is that the preparation of a surface and the application of coating are performed simultaneously by scanning the surface with separate two-phase flows.

Additionally, it is proposed that the surface scanning of the two-phase flow, that prepares the surface, has a linear velocity of movement along the scanned surface, which is equal to the linear velocity of movement along the scanned surface of the two-phase flow that applies the coating.

More specifically, the linear velocity of the two-phase flow movement along the scanned surface is proposed to be selected from the range of Vₘᵢₙ=0.7×k×L×ηₑᵣ to Vₘₐₓ=1.2×k×L×ηₑᵣ, where k=g/m is the ratio of the flow rate g of particles, used for preparing the surface, to the mass m of the removed surface layer within the processed spot; L is the longitudinal linear dimension of the two-phase flow spot at the processed surface; ηₑᵣ=(L−6d)/L—ratio of an effective longitudinal linear dimension of this spot to its linear dimension, where d—granulometric size of particles used for surface preparation.

In particular, it is helpful to isolate the area of the surface being processed from the environment.

In particular, it is useful to remove from the processing zone the powder suspension in gas, and deposition products, which remain after the surface processing.

More specifically during this process, the removed coating powder particles could be reused.

More specifically during this process, the particles used for surface preparation, after removal and separation, could be reused.

In particular, it might be useful to create lower static gas pressure, with respect to the environmental static gas pressure, in the surface processing zone.

In special cases, it might be necessary to expose the main processed surface material in the course of the surface preparation.

In particular, it might be necessary to select the gas velocity of the two-phase flow applying the coating to be greater than the sound velocity in gas.

Simultaneous scanning of the surface with separate two-phase flows for surface preparation and the application of coating allows minimizing of time between the completion of surface preparation process and the coating process. It makes possible to process surfaces, constantly exposed to periodic or random influences of adverse environmental factors, since it allows avoiding a direct environmental exposure of the processed surface area between these processes, without the need to insulate the article from the harmful environment. This permits applying coatings to a clean and dry activated surface, without an oxide film and with a necessary roughness. As a result, the adhesion of the coating material to the surface of the article is increased to the maximum, while decreasing significantly oxide inclusions in the transition zone/main material-coating. Moreover, the method may be easily implemented so that the trajectories along the processed surface of the two-phase flow spots are the same, both in preparing the surface and applying the coating. All these factors permit obtaining high quality coatings with a high level of adhesion and minimal oxide inclusions in the transition zone; maximum velocity of surface processing; and minimal consumables and energy consumption resulting in minimal discharges into the environment.

The same velocity of movement of two-phase flows allows for a concurrent preparation and activation of the surface to the required depth with a simultaneous application of coating to the required thickness. It also simplifies design of the system implementing the method.

Experimental results demonstrate that two-phase flows moving along a scanned surface with a linear velocity in the range between: Vₘᵢₙ=0.7×k×L×ηₑᵣ to Vₘₐₓ=1.2×L×ηₑᵣ, where k=g/m is the ratio of the flow rate g of particles, used for preparing the surface, to the mass m of the removed surface layer within the processed spot; L is the longitudinal linear dimension of the two-phase flow spot at the processed surface; ηₑᵣ=(L−6d)/L—ratio of an effective longitudinal linear dimension of this spot to its linear dimension, where d—granulometric size of particles used for surface preparation, allow designing a system with considerable surface processing automation, provided that the thickness and material of the layer to be removed in surface preparation, the longitudinal linear dimension of the spot, and the granulometric size of particles are known. The process is controlled by the flow rate of particles used for surface preparation. In order to obtain a sputtered layer with required parameters, the flow rate of the sputtered material is defined for a given surface preparation velocity.

By locally isolating a processed surface spot from the environment, surfaces permanently exposed to adverse environmental factors may be processed. Such an isolation may be noise-suppressing and dust-retaining. This is important for providing adequate sanitary conditions to personnel working in constrained places, and in order to minimize discharges into the environment.

Removing a powder suspension in gas, remained after surface processing, and removing the deposition substances from the surface processing zone results in improving environmental conditions of processing, and provides for reusing of consumables, so as to improve the financial performance of the process.

In the surface processing zone, the static gas pressure is lower than the static pressure in the environment. As a result, the sputtering chamber is pressed to the processed surface, thereby providing a simple implementation of an airtight connection of the sputtering chamber to the processed surface.

A sputtering layer better bonds with the processed surface because the main material of the processed surface is exposed in the course of its preparation.

The quality of the formed coating layer, physical and chemical properties of the coating, and its adhesion to the processed surface are improved because the two-phase gas stream flows with supersonic velocities.

As a result, the desired technical solution is achieved.

A method for surface preparation for subsequent application of coating is proposed. It includes surface processing with particles accelerated in gas flow. A distinctive feature of this preparation method is that the preparation is implemented by scanning the surface with a two-phase flow. The gas flow velocity is selected from a range between 0.5M and 1.2M, where M—Mach's number, the granulometric size of particles is selected from a range between 300 micron and 500 micron; linear surface velocity of the spot of accelerated particles is selected from a range between Vₘᵢₙ=0.7×k×L×ηₑᵣ to Vₘₐₓ=1.2×k×L×ηₑᵣ, where k=g/m is the ratio of the flow rate g of particles, used for preparing the surface, to the mass m of the removed surface layer within the processed spot; L is the longitudinal linear dimension of the two-phase flow spot at the processed surface; ηₑᵣ=(L−6d)/L—ratio of an effective longitudinal linear dimension of this spot to its linear dimension, where d—granulometric size of particles used for surface preparation.

Additionally, it is proposed to use as accelerated particles, the particles with hardness at least 1.1 times greater than the hardness of the removed layer material.

Additionally, it is proposed that while removing the outer layer, the gas flow temperature should be from 0.5Tₖ to 1.2Tₖ, where Tₖ—the boiling point of liquid that wets the surface.

Additionally, it is proposed to isolate the surface area being processed from the environment.

Additionally, it is proposed that gas static pressure in the surface processing zone is lower than the environmental static pressure.

Additionally, it is proposed to expose the main material of the surface being processed during surface preparation.

Additionally, it is proposed to remove from the surface preparation zone the powder suspension in gas and the removed-layer materials, which remained after surface preparation.

Additionally, it is proposed that after the removal and separation, the particles, used for surface preparation, should be reused.

Surface scanning with a two-phase flow provides for the surface preparation process accomplished by particles accelerated in the gas flow, as well as with the gas flow itself, which is important for preparation of wet surfaces. By varying the gas flow temperature from 0.5Tₖ to 1.2Tₖ, where Tₖ—the boiling point of the liquid that wets the surface, one can select energy efficient parameters, based on the type of the wetting liquid and the temperature of the processed surface.

The selection of velocity from the range between 0.5 M and 1.2M, where M—Mach's number, and the granulometric size of particles from the range between 300 micron and 500 micron, significantly influences the extent to which the particle-spot-boundary on the processed surface is washed out, the effectiveness of the outer layer removal to the required depth. It permits preparing the surface with a required roughness and without oxide film. It also permits the maximum activation of the boundary layers of the article's surface. As a result, the adhesion of coating material to the article's surface is increased up to the maximum value. For the above-mentioned combination of the gas flow velocities and the granulometric size of particles, it was proved experimentally that if the two-phase gas flow linear velocity along the scanned surface is chosen from the range between Vₘᵢₙ=0.7×k×L×ηₑᵣ to Vₘₐₓ=1.2×k×L×ηₑᵣ, where k=g/m is the ratio of the flow rate g of particles, used for preparing the surface, to the mass m of the removed surface layer within the processed spot; L is the longitudinal linear dimension of the two-phase flow spot at the processed surface; ηₑᵣ=(L−6d)/L—ratio of an effective longitudinal linear dimension of this spot to its linear dimension, where d—granulometric size of particles used for surface preparation, then it is possible to accurately calculate the mass of the removed layer material. As a result it is possible to calculate surface processing parameters with sufficient accuracy, thereby significantly automating the surface processing. The process is controlled by the particle flow rate, based on the gas flow velocity that accelerates the particles, when the material of the layer, removed in the course of the surface preparation, and its thickness, longitudinal linear dimension of the spot, and granulometric size of particles, used for surface preparation, are known.

By using the particles having hardness at least 1.1 times greater than the hardness of the layer material being removed, any surface layers are removed with minimal cost.

By isolating the processed surface area from the environment, undesirable discharge of consumables and removed materials into the environment is avoided.

Moreover, a noise-suppressing and dust-retaining isolation provides acceptable sanitary conditions for personnel, which is very important when working in constrained places.

The lowered pressure of gas in the surface processing zone, with respect to the static pressure of the environment, enables pressing the sputtering chamber against the surface being processed, thus providing for an airtight connection of the sputtering chamber with the surface being processed.

Exposing the surface being processed of the main material in the course of its preparation improves the sputtered layer adhesion with the surface being processed.

Removing a powder suspension in gas, remained after the surface processing, and removing the deposition substances from the surface processing zone results in improving environmental conditions of processing, and provides for reusing of consumables, so as to significantly improve the financial performance of the process.

As a result, the desired technical solution is achieved.

Also, a system is proposed for processing surfaces of articles, comprising a spraying unit for applying coating, which is implemented as an accelerating supersonic nozzle with means for supplying a carrier gas and means for supplying a gas-powder mixture into the spraying unit and the metering feeder. A distinctive feature of the proposed system is a spraying unit for surface preparation for a subsequent application of coating, which is implemented as an accelerating supersonic nozzle with means for supplying carrier gas, and means for supplying a gas-powder mixture into the spraying unit and a metering feeder. Each spraying unit is located in a separate chamber that has a socket for removing particle suspension from the processing zone and a window located so that the nozzle axis passes through the window area, and the spraying units are kinematically connected.

Additionally, it is proposed to manufacture the chamber using a gas-tight material.

Additionally, it is proposed to equip the chamber with a soundproof cover.

Additionally, it is proposed to implement a kinematical connection with a fixing element.

Additionally, it is proposed to implement a kinematical connection with means for shifting nozzles with respect to each other.

Additionally, it is proposed to equip the chamber with an airtight mechanism.

Additionally, it is proposed to equip the chamber with a mechanism for providing a contact between the chamber and the surface of the article.

Additionally, it is proposed to equip the chamber with a mechanism for moving the chamber along the surface of the article.

Additionally, it is proposed to manufacture chambers with connected adjacent walls.

The spraying unit for surface preparation for a subsequent application of coating provides for a simultaneous preparation of the surface for the application of coating and the application of coating to the prepared surface. As a result, the surfaces constantly exposed to adverse environmental factors are processed without removing the article out of the zone of the adverse factors while obtaining high quality coatings.

The spraying unit for surface preparation, designed as an accelerating supersonic nozzle, provides the required quality of surface preparation and the same trajectories of two-phase flows along the processed surface.

The spraying units are implemented as separate chambers with sockets for removing particle suspension from the processing zone, and windows, located so that the nozzle axis passes through the window area. This design allows avoiding discharges into the environment of powder used for surface processing and the substance removed from the surface. This enables decreasing the static gas pressure in the chambers with respect to the environmental gas pressure. Also the proposed system provides for the reuse of powder, thereby improving ecologic and financial indicators of the surface processing technology.

The kinematical connection between the spraying units provides that the trajectories of two-phase flows are the same when processing non-planar surfaces.

A gas-tight material of the chamber improves insulation between the space inside and outside of the chamber.

A soundproof cover of the chamber decreases noise level, which is very important in closed spaces.

The kinematical connection between fixing elements simplifies processing of flat surfaces.

The nozzle shifting element in the kinematical connection simplifies processing non-planar surfaces.

The sealing mechanism and the mechanism for pressing the chamber against the surface of the article prevent the surface processing from being impacted by the environment and avoid discharging a powder material into the environment.

The mechanism for moving the chamber along the surface of the article can be used to select the required processing speed, to obtain a uniform thickness of coatings, to avoid interference by human factors.

The chambers with connected adjacent walls prevent an impact of environmental factors on the surface being prepared in the period between the surface preparation and the application of coating, and eliminate interference between two-phase flows.

The above-listed essential features achieve a technical result solving the technical problem.

The methods are implemented, and the system operates, in the following way.

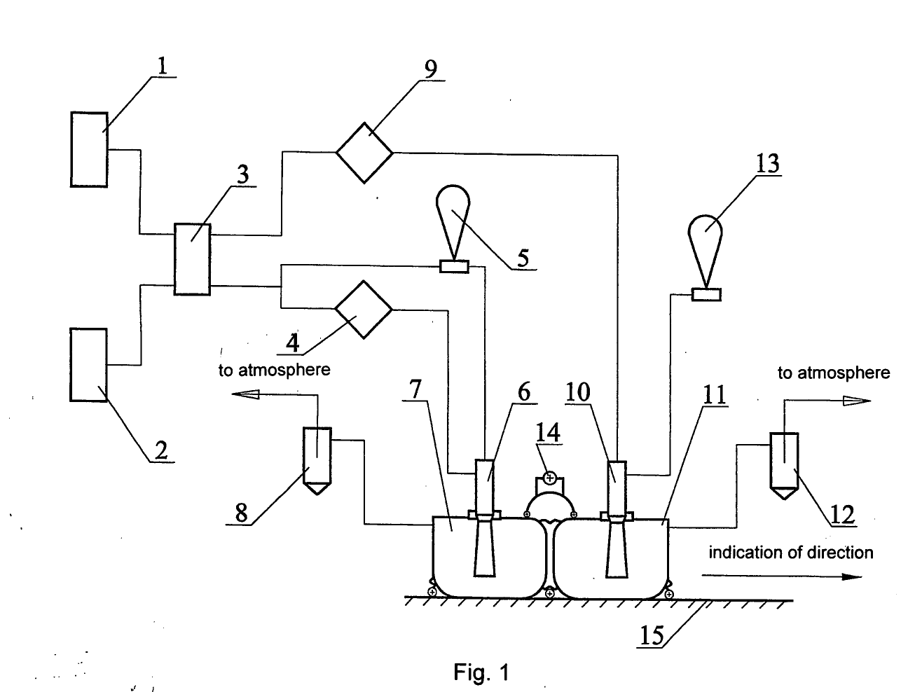

FIG. 1 is a block diagram of the main parts of the system;

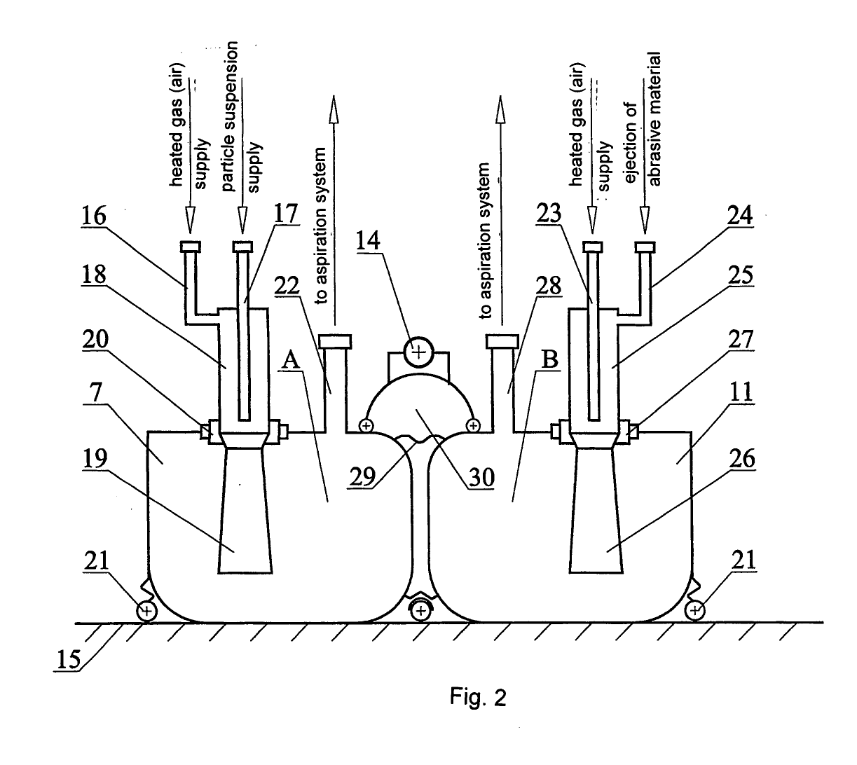

FIG. 2 illustrates preparation and spraying units of the system.

The proposed system comprises a compressed gas (air) supply 1 and an electric power supply 2, connected to the unit 3 controlling pneumatic and electric parameters of processing. The control unit 3 is connected to a gas heater 4, a metering feeder 5 for forced supply of the powder material into the sputtering unit 6, mounted on a movable gas-noise-insulating chamber 7, connected to an aspiration system 8. Control unit 3 is also connected to a gas heater 9, unit 10, which prepares the surface to be processed, is mounted on a movable gas-noise-insulating chamber 11, connected to an aspiration system 12 and a metering feeder 13, connected to a casing of unit 10. Chambers 7 and 11 with units 6 and 10, mounted on them, are flexibly connected to each other. They form a common surface preparation and coating sputtering block, which, by means of a pressure roll 14, moves with a predetermined speed in a predetermined direction along the surface of the article being processed 15.

The surface preparation and coating sputtering system (FIG. 2) comprises a sputtering block A and a surface preparation block B. Sputtering block A comprises a socket 16 for heated gas (air) supply, a socket 17 for supplying particle suspension into chamber 18 for gas flow leveling, and an accelerating supersonic nozzle 19 connected using a fixing element 20 to the casing of the movable gas-noise-insulating chamber 7, which is moved, by means of sealing rollers 21, along the surface of the article 15 being processed. The gas-noise-insulating chamber 7 has a socket 22 for removing suspension of powder material particles, which was not deposited to the processed surface, into the aspiration system 8. The surface preparation block B comprises a socket 23 for heated gas (air) supply, socket 24 for ejection of abrasive material into an ejection chamber 25 with an accelerating nozzle 26, connected by a fixing element 27 to the casing of the movable gas-noise-insulating chamber 11, which is moved, by means of sealing rollers 21, along the surface of the article 15 being processed. The gas-noise-insulating chamber 11 has a socket 28 for removing suspension of abrasive particles into the aspiration system 12. The interconnection of the sputtering block A and the surface preparation block B is implemented using kinematical fixing elements 29 and 30, which enable blocks A and B to move to a predetermined angle with respect to each other, which is necessary for processing curved surfaces. When processing elongated and large articles, the pressure roller 14 is used, which moves, with a predetermined force and predetermined speed, the surface preparation and sputtering system along the surface of the article being processed.

The system operates as follows:

Gas (air), under pressure, from the compressed gas supply 1 and electric power from the electric power supply 2 are provided to the control unit 3, where they are adjusted to the required values. Gas and electric power are supplied from the control unit 3 to the gas heater 4, where the gas is heated to the temperature required for the application of coating. The heated gas flows from the gas heater 4 through pipeline and the socket 16 for providing heated gas, into the gas flow leveling chamber 18. The gas flows out through the accelerating supersonic nozzle 19 into the gas-noise-insulating chamber 7 and then to the surface 15 of the article. Also, from the control unit 3, gas and electric power are supplied to the gas heater 9, where the gas is heated to the temperature required for drying and accelerating the abrasive particles. The heated gas flows through the socket 23, for providing heated gas, into the ejection chamber 25, and flows out of it through the accelerating nozzle 26 to the gas-noise-insulating chamber 11 and then to the surface 15 of the article being processed. When the required parameters of the gas flows, in the accelerating nozzles 18, 25, are achieved, the pressure is supplied to the metering feeder 5. At the metering feeder 5 for forced supply of the powder material, the coating material particles are entrained and transported by the air flow through the socket 17, for particle suspension supply, to the gas flow leveling chamber 18, and they are further accelerated in the accelerating supersonic nozzle 19 to the velocity required for the coating formation. The accelerated coating-material particles reach the surface on the article being processed hit it and form the coating. When the heated gas flows from the gas heater 9 through the socket 23 and through the accelerating nozzle 26, low pressure is created in the ejection chamber 25, resulting in the gas with abrasive material flowing out from the metering feeder 13 through the socket 24 to the chamber 25, entraining the abrasive particles by the heated gas flow and their acceleration in the accelerating nozzle 26. Thus, the accelerated abrasive material particles and the heated to the required temperature gas hit the surface of the article being processed, clean and dry the surface area, preparing it for the application of coating. After achieving the required process parameters, the system moves by means of pressing roller 14 at a predefined velocity towards the area being processed, so that the sputtering unit 6 applies the coating to the surface simultaneously being cleaned and dried by the preparation unit 10. Sealing rollers 21 provide for moving the system along the surface of the article-being-processed 15 and sufficient air-tightness between the article 15 surface and the gas-noise insulating chambers 7, 11, from which the residual suspension of particles in gas is removed through the sockets 22, 28 at a pressure below the environmental one, through a separate aspiration systems 8, 12. The supply of the gas and electric power is turned off after the processing of the surface area has been completed. Residual powder and abrasive material from aspiration systems 8, 12, could be reused in the described processes after drying, separation and processing.

Examples of the Use of the Invention.

A metal structure is located in an open water space. The above-water part of the metal structure and the water-atmosphere transition zone, wetted periodically due to tides and waves on the water surface, are the most affected by corrosion. Environmental conditions: humidity 100%, air temperature +30° C. Under realistic conditions, the above-water part of the surface of the structure is covered by a wet layer of salt deposits and metal oxide of varying thickness and composition; the transition zone is covered by seaweeds, shell rock, salt deposits and metal oxide of varying thickness and composition as well. It is necessary to clean the the surface of the structure up to the main metal and apply a high quality protective coating to this cleaned surface, so as to prevent corrosion caused by environmental impact.

1. Processing of the Above-Water Part of the Metal Structure.

If it is possible using a device or mechanically, the average thickness and density of deposits are determined. The velocity of movement of the surface processing system along the processed area is determined using empiric formula V=L×ηₑᵣ×g/m. Then, the system is placed at the surface being processed, the chamber is pressed to the surface being processed with a pressure device, a power source is connected, abrasive particles are put into the metering feeder, the mechanism for moving is connected, and an experimental start is performed with this velocity. Based on the obtained results, the velocity is corrected. In case of an increased depth of the material being removed, caused by inaccurate determination of the layer density and thickness, one should increase the linear velocity by the value of h_{lay}/hₑᵣ, where h_{lay} is the thickness of deposits, and hₑᵣ is an actual depth of erosion. In case of insufficient depth, one should reduce the velocity by the value determined by the same formula. Having determined the actual speed of movement and having defined the required thickness of coating, one can determine the consumption of powder material from g=m/t, where m is the mass of powder material per a surface unit, determined from m=q×S×h_{surf}η_{surf}, where q is density of the coating powder material, S is the sputtered area, h is the thickness of the formed coating, η_{surf}=L/(L−3f)—the experimentally obtained ratio of the linear dimension of the processed spot to the effective linear dimension of the sputtering gas-powder stream, f=(1.0-1.2)mm—thickness of the decelerating boundary layer for particles in the gas of the accelerating nozzle (4), t—time, determined from the speed obtained before. Having determined the surface processing parameters, a control run of surface processing is performed while measuring the thickness of the applied coating.

Processing of the Transition Zone

One should mechanically remove seaweeds, shell rock and other non-dense depositions from the transition zone surface, until the dense sedimentary layers are exposed. One should determine the average thickness of the sedimentary layer, its approximate composition and the movement speed of the system. One should attach the system to the surface being processed, attach a power source, put the abrasive material (powder for surface preparation) into the metering feeder, press the chamber with a pressure device, and turn on the aspiration system, thereby creating low pressure in the gas-noise insulating chamber, turn on the movement mechanism and make an experimental run. Subsequent steps are described in the previous example.

### SPECIFIC EXAMPLE

The surface of a metal structure being processed is covered by a wet layer of lime salt deposit and rust having thickness h=1 mm. The diameter of the processed spot is D=10 mm. Erosive processing is performed by a two-phase flow at a temperature +80° C., gas flow velocity M=1, the consumption of abrasive material g=0.3 g/s and a granulometric size of particles d=500 micron. Let's determine the mass of the layer removed from the spot being processed: m=q×s'h, where q=2.7 g/cm³ is average density of the erosive processing layer, S=78.5 mm² is the processed spot area, h=1 is the processed spot thickness. By substituting these values, one determines m=2.7×10⁻³ g/mm³×78.5 mm²×1 mm=0.21 g. Linear velocity of movement is V=L×ηₑᵣ×g/m, where ηₑᵣ=(L−6d)/L=(10−6×0.5)/10=0.7; hence V=0.3 g/sec/0.21 g×10 mm×0.7=10 mm/sec or 600 mm/min. After a control run with the calculated velocity of movement 10 mm/sec, we measure the erosion depth. Based on the measurement, h=1.2 mm, which exceeds the required depth of processing by 0.2 mm. We change the velocity of movement by the value of h_{lay}/hₑᵣ=1 m/1.2 mm=0.83, which makes V=10 mm/sec/0.83=12 mm/sec. To apply coating with thickness of h=100 micron=0.1 mm, let us determine the required mass of powder material, e.g. Zn, for the sputtered spot area of S=78.5 mm², with a linear size of L=10 mm, by formula:
m_{surf}=q×S×h_{surf}×η_{surf}=7.1 g/mm³×10⁻³×78.5 mm²×0.1 mm×1.43=0.79 g , where η_{surf}=L/(L−3 f).
The zinc powder consumption will be: g=m×V/L=0.79 g×12 mm/sec/10 mm=0.94 g/sec. Having determined the required parameters, we process the surface of the article.

### Example 2

A reinforced concrete structure being processed is covered by environmental deposits, having a depth of moisture penetration in pores h=1.5 mm. The diameter of the spot, which is being processed, is D=10 mm, the area of the spot being processed is S=78.5 mm², the temperature of the two-phase abrasive flow is +100° C., the gas flow velocity is M=1, the consumption of the abrasive material is g=0.3 g/sec, the granulometric size of abrasive particles is d=500 micron, the average density of deposits is q=2.4 g/cm³. The mass of the layer, which is removed from the spot being processed: m=q×S×h=0.28 g, linear velocity of movement: V=L×ηₑᵣ×g/m=7.5 mm/sec. After a control run, the actual depth of erosion was h=1.2 mm. We correct the velocity of movement: h_{lay}/hₑᵣ=1.25, which makes V=6 mm/sec. To apply an aluminum coating having thickness of 200 micron, let's determine the required mass of the aluminum powder per area of the sputtering spot of m=q×S×h×η_{surf}=0.6; the consumption mass is g=mV/L=0.36 g/sec. After selecting the required parameters, we process the surface of the reinforced concrete structure.

### Example 3

The recovery of a corrosion-damaged spot of a metal structure to its initial size. On the surface on an article, there is a 5 mm deep and 10 mm in diameter corrosion cavity, having a cone shape, with an oxide/rust layer h=0.1 mm thick. We place the abrasive-particles accelerating nozzle at the corrosion cavity and conduct the erosive processing of the cavity with a two-phase flow with parameters: T=20° C., M=1, g=0.3 g/sec, d=500 micron. The oxide layer mass, being removed, is m=0.3 g, the processing time is t=1 sec. Let's determine the required consumption of powder material for the cavity recovery: m=1.02 g. The powder material consumption is selected at g=0.5 g/sec and the sputtering time is determined as: t=2.04 sec. We place the supersonic nozzle, which accelerates the coating-material particles, at the prepared and processed cavity and apply the coating. Then, we mechanically remove the surplus of the applied material and level the surface.

The described invention allows processing of surfaces of large-size articles, made of different materials, under adverse external and environmental conditions, both in an open space and in a restricted space.

Concurrent erosive processing and drying, with a heated gas flow, processes remove contaminations (such as moisture, oxide films, various organic and mineral compounds) from the surface of an article being processed, thereby exposing the surface layer of the material. Applying, simultaneously with this process, powder coating to this cleaned and prepared surface allows obtaining the coatings with improved structure, without a transitional oxide zone (the article material—the coating particle) with an increased adhesion and a higher coating material utilization ratio. Removing the suspension of abrasive particles and powder, and subsequently collecting and reusing those cause the process to be more efficient and environmentally friendly. By moving the system uniformly and automatically controlling the supply of particles to the zone being processed, a coatings is obtained, which is both homogeneous and with uniform in thickness.

Thus, the proposed method and a system for its implementation allow processing of surfaces of various shapes and configurations, both large-size and small-size, under unfavorable conditions (increased humidity, permanent wetting, aggressive environment, temperature gradients, etc.) as well as in manufacturing facilities. The processes of surface processing are sufficiently efficient and cost-effective, they ensure a high output productivity and quality, broaden the area of surface processing applications.

### REFERENCES

1. Method for gas-thermal application of coatings. Patent RF No. 2086697, MPK S23S 4/12.
2. Method for jet-abrasive processing. Patent RF No. 2140843, MPK V24S1/00.
3. Device for gas-dynamic application of coatings with powder materials. Patent RF No. 2100474, MPK S23S 4/00, V05V 7/00, S23S 26/00.
4. Abramovich G. N. Applied gas dynamics. M, Nauka, 1969, pp. 277-283.

1. A method for processing surfaces of articles, comprising preparing a surface and applying a coating by accelerated particles, characterized in that the surface preparation and the application of coating are performed simultaneously by scanning the surface with separate two-phase flows.

2. The method of claim 1, characterized in that the surface scanning is performed with linear velocity of movement of the two-phase flow along the surface, preparing the surface, which is equal to the velocity of movement along the scanned surface of the two-phase flow applying coating.

3. The method of claim 2, characterized in that the linear velocity of movement of the two-phase flow is selected from the range between Vₘᵢₙ=0.7×k×L×η and Vₘₐₓ=1.2×k×L×η, where k=g/m—ratio of the flow rate g of particles, used for surface preparation, to the mass m of surface layer being removed within the processed spot, L—longitudinal linear dimension of the two-phase flow spot at the processed surface, η=(L−6d)/L—the ratio of effective longitudinal linear dimension of this spot to its linear dimension, where d—maximum granulometric size of particles, used for surface preparation.

4. The method of claim 1, characterized in that the surface area being processed is isolated from the environment.

5. The method of claim 1, characterized in that residual powder suspension in gas and deposition products, which remain after surface processing, are removed from a zone being processed.

6. The method of claim 5, characterized in that the removed coating powder particles are reused.

7. The method of claim 5, characterized in that the particles used for surface preparation, after their removal and separation, are reused.

8. The method of claim 1, characterized in that a gas static pressure in the surface processing zone is made lower than the environmental static pressure.

9. The method of claim 1, characterized in that the main material of the surface being processed is exposed during surface preparation.

10. The method of claim 1, characterized in that the gas velocity in the two-phase flow, applying the coating, is greater than the sonic velocity in gas.

11. A method of surface preparation for subsequent application of coating, comprising processing of surface with particles, accelerated in a gas flow; characterized in that the preparation is performed by scanning the surface with a two-phase flow, wherein the gas flow velocity is selected from a range of velocities between 0.5 M and 1.2M, where M—Mach's number, granulometric size of particles is selected from a range between 300 micron and 500 micron, linear velocity of movement of a spot of accelerated particles along the surface is selected from a range between Vₘᵢₙ=0.7×k×L×η and Vₘₐₓ=1.2×k×L×η, where k=g/m—the ratio of the flow rate g of particles, used for surface preparation, to the mass m of surface layer being removed within the spot being processed, L—longitudinal linear dimension of the two-phase flow spot on the surface being processed, η=(L−4d)/L—the ratio of effective longitudinal linear dimension of this spot to its linear dimension, where d is the maximum granulometric size of particles used for surface preparation.

12. The method of claim 11, characterized in that accelerated particles have hardness at least 1.1 times greater than the hardness of the removed layer material.

13. The method of claim 11, characterized in that the outer layer is removed at the gas flow temperature from 0.5Tₖ to 1.2Tₖ, where Tₖ—the boiling point of liquid that wets the surface.

14. The method of claim 11, characterized in that the surface area being processed is isolated from the environment.

15. The method of claim 11, characterized in that a gas static pressure in the surface processing zone is made lower than the environmental static pressure.

16. The method of claim 1, characterized in that the main material of the surface being processed is exposed during surface preparation.

17. The method of claim 11, characterized in that the residual powder suspension in gas and removed layer materials, remaining after surface preparation, are removed from the surface preparation zone.

18. The method of claim 17, characterized in that the particles used for surface preparation, after removal and separation, are reused.

19. A system for processing surfaces of articles, comprising a spraying unit for application of coating, implemented as an accelerating supersonic nozzle with carrier gas supplier and a gas-powder mixture feeder to the spraying unit and to the metering feeder; characterized in that it has, additionally, a spraying unit for surface preparation for subsequent application of coating, implemented also as an accelerating supersonic nozzle with a carrier gas supplier and a gas-powder mixture feeder to the spraying unit, and to a metering feeder; wherein each spraying unit is located in a separate chamber that has a socket for removal of particle suspension from the processing zone and a window located so that the nozzle axis line passes through the window area, and the spraying units are kinematically inter-connected.

20. The system of claim 19, characterized in that the chamber is manufactured of a gas-tight material.

21. The system of claim 19, characterized in that the chamber is covered with a sound-proof cover.

22. The system of claim 19, characterized in that the kinematical connection contains a fixing element.

23. The system of claim 19, characterized in that the kinematical connection contains an element for displacement of nozzles with respect to each other.

24. The system of claim 19, characterized in that the chamber is equipped with a sealing mechanism.

25. The system of claim 19, characterized in that the chamber is equipped with a mechanism for pressing the chamber against the surface of article.

26. The system of claim 19, characterized in that the chamber is equipped with a mechanism for moving the chamber along the surface of the article.

27. The system of claim 19, characterized in that chambers are manufactured with connected adjacent walls.
